(19) United States
(12) Patent Application Publication
(10) Pub. No.: US 2004/0139186 A1
(43) Pub. Date: Jul. 15, 2004

(54) Apparatus and method for recommending alternative components based on performance measurement results of components

(76) Inventors: Ji Hyun Lee, Taejon (KR); Oh-Cheon Kwon, Taejon (KR); Woo-Sik Kim, Inchon (KR); Gyu-Sang Shin, Taejon (KR)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 10/404,331

(22) Filed: Apr. 2, 2003

(30) Foreign Application Priority Data
Dec. 20, 2002 (KR) 2002-81820

(51) Int. Cl. G06F 15/173

(52) U.S. Cl. 709/223

(57) ABSTRACT

Disclosed are an apparatus and method which visualizes the result of performance measurement obtained by executing of a method that measures performance of components, performs performance comparison, generates association rules by analyzing a list of associated components through the performance comparison of the correlated components selected by a user, and automatically recommends the alternative components by searching relation analysis information for the specific component. The apparatus includes a component performance measurer for generating a performance measurement program for the components and measuring the performance of the components by executing the program, a component performance comparator for comparing the performances of the components selected by a user according to performance measurement elements, a component repository for storing the specification information of each component, the performance measurement result information and the performance comparison result information, an associated component analyzer for searching for association rules by analyzing the component comparison list information, and an alternative component recommender for recommending alternative components to users in the order of their association degree with respect to a specific component.

### BACKGROUND OF THE INVENTION

1. Field of the Invention

The present invention relates to an apparatus and method for recommending alternative components based on performance measurement results of components; and, more particularly, to an apparatus and method for recommending alternative components based on performance measurement results of components, which visualize the result of performance measurement obtained by execution of methods, generate association rules by analyzing a list of alternative components comparing performance measurement of the correlated components, and automatically recommends the alternative components by searching association analysis information for a single component.

2. Background of the Invention

A component is a reusable software unit having functions and a specification of the functions. In order to accelerate software development, the reuse of previously built components is very important to software system development. In Component Based Software Development (CBSD), the functions of the component are reused for developing the same functions of the component to a function part to be newly generated, and the maintenance and repair is achieved by replacing the component to be changed with a new component. Accordingly, in order to heighten the reuse of the previously generated components, a component repository has been researched so as to store and manage the generated components, and to find and use the components needed by a developer. The conventional component repository supports the component identification only by browsing or query. However, the conventional component repository has the disadvantages in that in case of the browsing, the search area for finding a desired component is too wide, and in case of the query, a desired component cannot be found if the user does not input a desired keyword.

Thus, an easy identification of the component required by the user and identification of components with a similar function are not effectively performed using the conventional component repository.

Specifically, since a large-scaled component repository cannot easily recognize the existence of the component desired by the component user and also cannot identify the adequate components, the component developers should repeatedly re-generate the methods with the same functions.

Meanwhile, the conventional method to measure component performance generally requires source code, and if there is not the source code, the method obtains the source code by decompiling binary files corresponding to a component, and measures the performance of the component by inserting a method of the component into a performance measurement program.

In “An active and adaptive reuse repository system” published in March 2001, the system analyzes the similarity of components using an identifier in source code, annotation, the text information of a method signature, and user profiles in order to identify the reusable components.

However, since the commercial components are composed of only binary execution files generated from source code, and prevent a binary execution file from being calculated the source code by applying a decompiling prevention technique, it is required to change input data in order to analyze the alternative components.

Also, although the component search is performed by directly using a query, finding a component corresponding to the query, and providing the component as the reusable component, the keyword search method is in close connection with how well the keyword for the query expresses the component to be found. Accordingly, if a proper keyword is not used, a desired component cannot be found from the reusable component repository, requiring a more efficient search method.

In “JaViz: A client/server Java profiling tool” printed in November 2000, a method call relation generated by calling remote methods of a Java application program of a distributed environment is shown as a tree structure of visualized program execution. In the method call relation graph of the tree structure shown in JaViz, execution times and call relations recorded on Java Virtual Machines (JVM) of the client and server sides are gathered and integrated to be shown to users.

However, since the performance measurement operations are all performed on the Java Virtual Machines, the performance measurement elements are limited, and it is difficult for the user to understand or compare the performances.

In “A tool for monitoring software-heterogeneous distributed object applications” published on June 1995, when components are combined in order to construct distributed applications, dynamic system structures and operations such as an object generation and object deletion are measured and visually shown. Thus, the structural imbalance of the constructed applications can be detected, and the overload interacting in the added component software is detected so that they can be used for the system tuning.

However, since the prior researches merely generate and show information on the component operation and the structure and operation of the application program in a tree structure, and the performance measurement elements are limited, it is difficult for the user to understand or compare the performances. In addition, the component search that matches the user's request cannot efficiently be performed. Accordingly, there still exist the technical limitations in measuring diverse performances of the component, understanding results of performance measurement, and identifying alternative components.

### SUMMARY OF THE INVENTION

Accordingly, the present invention is directed to an apparatus and method for recommending alternative components based on performance measurement results of components, which substantially solves one or more problems due to limitations and disadvantages of the related research.

It is an objective of the present invention to provide an apparatus and method for recommending alternative components based on performance measurement results of components which can seek the user's convenience during a search for the desired components, elevate the reuse rate of the components, and efficiently construct component based software by analyzing a list of retrieved components, comparing performances of the components based on the performance measurement results of the respective components, automatically selecting and providing a component that matches well with a component reuser's requirements.

Additional advantages, objective, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

In order to achieve the above objectives, there is provided an apparatus for recommending alternative components based on performance measurement results of components, including:

a component specification information input interface for receiving a user's input of component specification information and application server connection information;

a component method extractor for extracting method signatures of the component based on the entered component specification information;

a component performance measurer for generating a performance measurement program for the components by reflecting the extracted method signature information, the number of repeated method execution inputted by the user, and the number of users simultaneously connected, calling functions of the component deployed in the application server by executing the performance measurement program, and then measuring an internal performance of the component;

a component selection interface for performance comparison for receiving selection information of the components to compare the measured performance of the components;

a component performance comparator for confirming the performance measurement results of the selected components and then comparing the performances of the components according to each performance measurement elements;

a result graph generator for generating a graph corresponding to each performance element using a single-component performance measurement result to show the graph to the user, and generating a graph corresponding to each performance element using performance comparison results to show the graph to the user;

a component repository for storing specification information about each components, the performance measurement result, the performance comparison result, and compared-components list;

an associated component analyzer for searching for specific associated component list by analyzing the compared component list information, and extracting association rules based on the associated component list; and

an alternative component recommender for selecting and recommending alternative components in the order of their association degree of a specific component based on the association rules and the performance measurement information about each component if a user requests the alternative component list of the specified component.

In another aspect of the present invention, there is provided a method for recommending alternative components based on performance measurement results of components, including the steps of:

a component specification information input step of receiving a user's input of component specification information, the repeated number of method execution of the methods, the number of users simultaneously connected, and application server connection information;

a component method extraction step of extracting method signatures of the component based on the input component specification information;

a component performance measurement step of generating a performance measurement program for the component by reflecting extracted method signature information, the repeated number of method execution, and the number of users simultaneously connected, calling functions of the component deployed in the application server by executing the performance measurement program, and then storing measurement results of each component;

a component performance comparison step of, if a user selects components to compare performance results among the measured components, confirming the performance measurement results of the components to compare, comparing the performances of the components according to a performance measurement element, and storing comparison result information and compared performance measurement log;

an associated component list analysis step of searching for an associated component list by analyzing the compared component list information at the component performance comparison step, and extracting association rules based on the associated component list; and

an alternative component recommendation step of selecting and recommending alternative components in the order of their association degree of a specified component using the association rules information and the performance measurement result information of the specific component if a user requests the alternative component list of the specified component.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which provide a further understanding of the invention and illustrate embodiment(s) of the invention together with the description to explain the principle of the invention. In the drawings:

FIG. 1 is a block diagram of an apparatus for recommending alternative components according to the present invention.

FIG. 2 is a view illustrating a user interface for inputting component specification information and application server information according to the present invention.

FIG. 3 is a view illustrating a user interface for selecting components to compare measured performances according to the present invention.

FIG. 4 is view illustrating a user interface of a result graph generator for generating as a comparison graph using the results of the component performances that have been measured according to the present invention.

FIG. 5 is a graph illustrating the performance of a usage-rate for a memory and the performance of a usage-rate for a CPU according to the present invention.

FIG. 6 is a graph illustrating the performance of a method response time and the performance of a component response time according to the present invention.

FIG. 7 is a view illustrating a method for extracting association rules by analyzing the support and confidence of associated components based on the performance measurement comparison log.

FIG. 8 is a view illustrating a display of a component recommendation result according to the present invention.

FIG. 9 is a flowchart illustrating a method for recommending alternative components based on a component performance measurement according to the present invention.

### DETAILED DESCRIPTION OF THE PREFERRED EMBODIMENT

Now, the preferred embodiment of the present invention will be explained in detail with reference to the accompanying drawings.

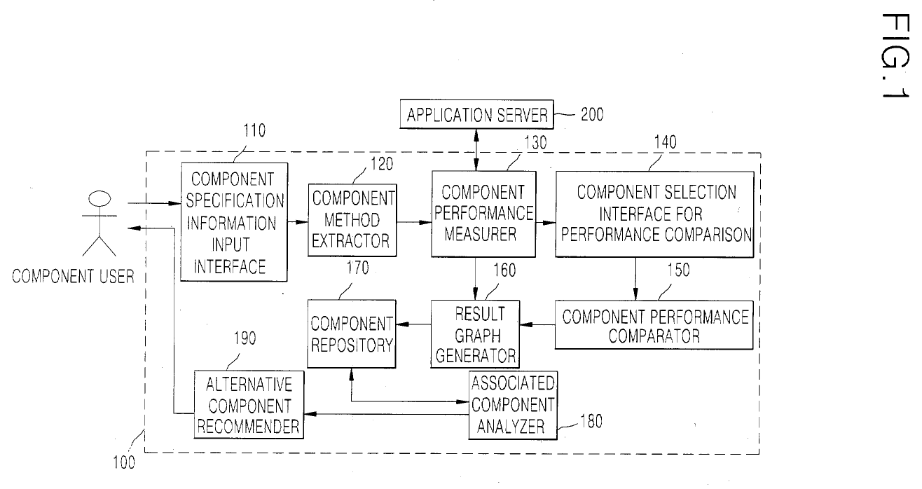

FIG. 1 is a block diagram of an apparatus for recommending alternative components according to the present invention.

As shown in FIG. 1, the alternative component recommendation apparatus 100 according to the present invention includes:

a component specification information input interface 110,

a component method extractor 120,

a component performance measurer 130,

a component selection interface for performance comparison 140,

a component performance comparator 150,

a result graph generator 160,

a component repository 170,

an associated component analyzer 180, and

an alternative component recommender 190.

If a user inputs the information of a component specification and application server through the component specification information input interface 110,

the component method extractor 120 extracts method signatures based on the input information, and the component performance measurer 130 automatically generates a component performance measurement program based on the extracted method signatures, the repeated number of method execution, and the number of users simultaneously connected, measures performance of the component by executing the program and calling the functions included in the corresponding component deployed in the application server 200, and then stores results of the performance measurement in the component repository 170.

If the user selects the components for performance comparison through the component selection interface for performance comparison 140 after the performances of the components deployed in the application server 200 are measured,

the component performance comparator 150 compares the performances of the selected components according to a specific performance element, generates a graph of comparison result for the user through the result graph generator 160,

and then stores the performance comparison results and compared component list information in the component repository 170.

The associated component analyzer 180 generates a list of components that have a high degree of association and can use together, by analyzing performance comparison information generated from performance comparison results, and generates association rules using a list of the components.

Also, if a user requests the recommendation of the alternative components for the specific component, the alternative component recommender 190 provides the user with the list of the components in the order of their association degree using the analyzed association rules.

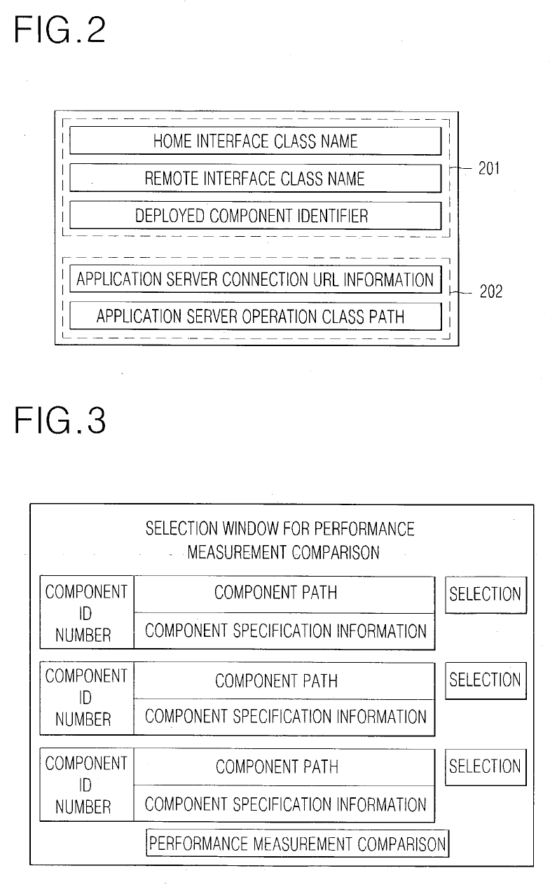

Hereinafter, the structure of the alternative component recommendation apparatus for the present invention will be explained in detail with reference to FIGS. 2 to 7.

The component specification information input interface 110 is a Graphic User Interface (GUI) that receives the component specification information from a user, and receives interface class names which are a business method set of a component, and the connection information of the application server in which the component is deployed.

FIG. 2 shows the window of a component specification information input interface. The component specification information input interface 110 receives the component specification information 201 and the application server connection information 202 from a user.

This component specification information 201 may be a home interface class name, a remote interface class name, an identifier of the deployed component, etc., and the application server connection information 202 may be the connection URL information and paths of classes for running the application server.

The component method extractor 120 extracts method signatures of the component from the entered component specification information.

The method signature is extracted as it is divided into a method name, parameter types, and a return type.

The component performance measurer 130 automatically generates a program for measuring component performance using the method signature information extracted from the component method extractor 120, and diverse user scenarios such as the repeated number of method execution and the number of users simultaneously connected.

Also, the component performance measurer 130 calls the functions of the component deployed in the application server 200 by executing the generated performance measurement program, and then measures the performance of the component based on the scenario set by the user.

At this time, the measured functions of the component may be the response time of each method, a component response time calculated as the sum of the response time of methods, a CPU usage rate per time unit, a memory usage rate, the summation information of method response time calculated as an average and deviation of the method response time, the summation information of CPU variation amount, and the summation information of memory variation amount.

If performances of a component are measured as above, the component performance measurer 130 stores specification information, method signature information, and performance measurement information of the component according to the user in the component repository 170.

Also, the result graph generator 160 generates a graph corresponding to each performance element using the performance measurement results on the user's request, and shows the graph to the user.

That is, the performance of the component response time shows a component name as a bar graph, the performance of the method response time shows the response time for each method signature of the component as a bar graph, and the performances of the CPU usage rate and memory usage rate show the variation of the CPU or memory usage rate per time unit as a bent-line graph.

If the performances of components deployed in the application server 200 are measured, and the performance measurement results of the components are stored in the component repository 170, the user can request the performance comparison of the components, the association rule generation, and the recommendation of the alternative components using the performance measurement results.

The component selection interface for performance comparison 140 is a graphic user interface of selecting the components according to the user's performance comparison from the performance-measured components.

The component selection interface for performance comparison 140 is exemplified in FIG. 3. The user confirms the specification information of components, selects the components to compare performance, and then requests the performance comparison measurement for the selected components.

Accordingly, the component performance comparator 150 confirms the performance measurement results of the selected components in the component repository 170, compares the performances of the components according to performance measurement element, and stores the comparison result data in the component repository 170 as a performance comparison log.

Also, the result graph generator 160 converts the component performance comparison results into a visual graph according to performance elements so that the user can easily understand the performance comparison results.

That is, the result graph generator 160 shows the performances of the component response time and the method response time according to component names or method signatures as a bar graph, and shows the performances of the CPU response time and the memory response time per time unit as a bent-line graph.

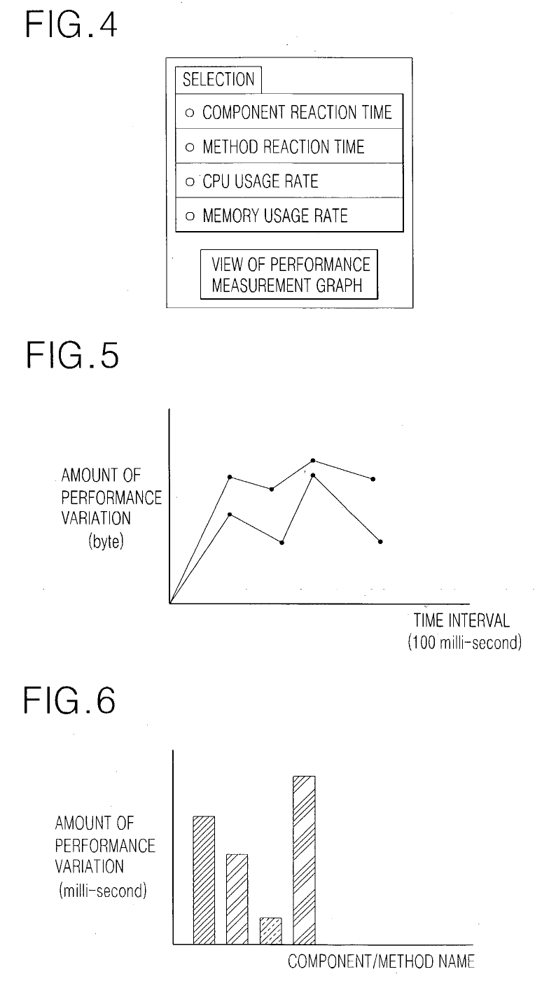

FIG. 4 shows a window of the user's request for the performance comparison result graph in the result graph generator 160. The user can select specific performance elements and request the performance comparison graph of the selected components.

FIG. 5 shows a bent-line graph illustrating the performance of the CPU usage rate and the performance of the memory usage rate. FIG. 6 shows a bar graph illustrating the performance of the component response time or the performance of the method response time.

In the component repository 170 are stored the specification information inputted for the components, the extracted method signature information, the performance measurement results, the performance comparison results, and the performance-measured component information.

The associated component analyzer 180 searches an associated component list and degree of association that exists between the components using the performance comparison results, generates association rules based on the associated component list.

That is, the associated component analyzer 180 decides that the frequently performance-compared components have a high degree of mutual association using the performance information of the components selected together in the performance comparison process.

The degree of association between the components according to the association rules is expressed by the support and confidence.

The support becomes the number of selection of a specific component as the subject of comparison in all user data of a list of the compared components. The confidence is used for expressing the reliable degree of association between a specific component and other components.

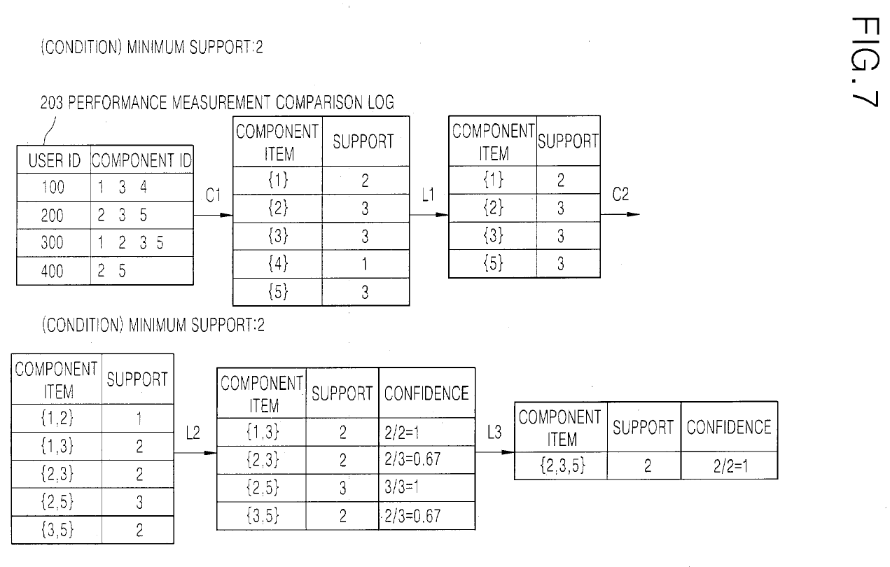

That is, in FIG. 7, the support of a component 2 is 3, and the confidence of a component 5 to the component 2 is 1. The support of the component 2 to components 3 and 5 is 2, and the confidence is 1.

The associated component analyzer 180 analyzes the association rules composed of component items by numerically calculating the support and the confidence of each component item.

FIG. 7 shows a method of obtaining Cl from a performance measurement comparison log 203 of all the users that is the component list data requested by the user during the component performance measurement comparison, and finding the component list L2 having the higher support than the minimum support as increasing the associated components one by one. The method extracts the associated component lists by repeatedly finding the associated component lists (Ln, n=1, 2, 3, . . . ) until no more associated component list can be found. The associated component lists (Ln, n=1, 2, 3, . . . ) are used as the association rules for searching for the alternative components.

The alternative component recommender 190, when the user requests the alternative component list of a specific component, automatically recommends the alternative components in the order of the degree of association using the list information of the associated components extracted by the associated component analyzer 180, and the performance measurement information of the component measured by the component performance measurer 130.

In order to select the recommended components with a high degree of association and performance required by the user, the alternative component recommender 190 uses the extracted list information of associated component (i.e., the calculated association rules) and the performance measurement information of each component (i.e., the average and deviation of measurement items of each component, the number of methods which show the minimum response time, and the number of methods which show the maximum response time).

When the alternative component recommender 190 recommends the alternative components for the specified component, the components with the high support and confidence are first recommended, and in case that the components have the same support and confidence, the priority of recommendation is determined in the order of their high average of performance measurement items, small deviation, a large number of methods that show the minimum response time, and a small number of methods that show the maximum response time.

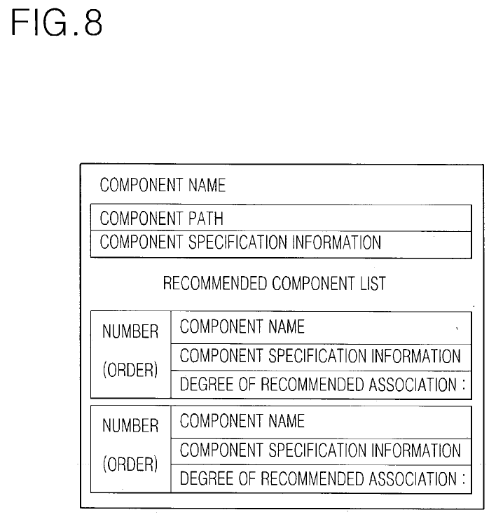

FIG. 8 is a view illustrating an alternative component recommendation shown to the user. A recommended component list is provided for a specific component, and is composed of a recommendation order of a recommended component, a name of the recommended component, component specification information, a degree of recommended association, etc.

Consequently, the user can confirm specification information for each component of recommended component list and its recommendation association, and can select the proper components to use them as reusable components.

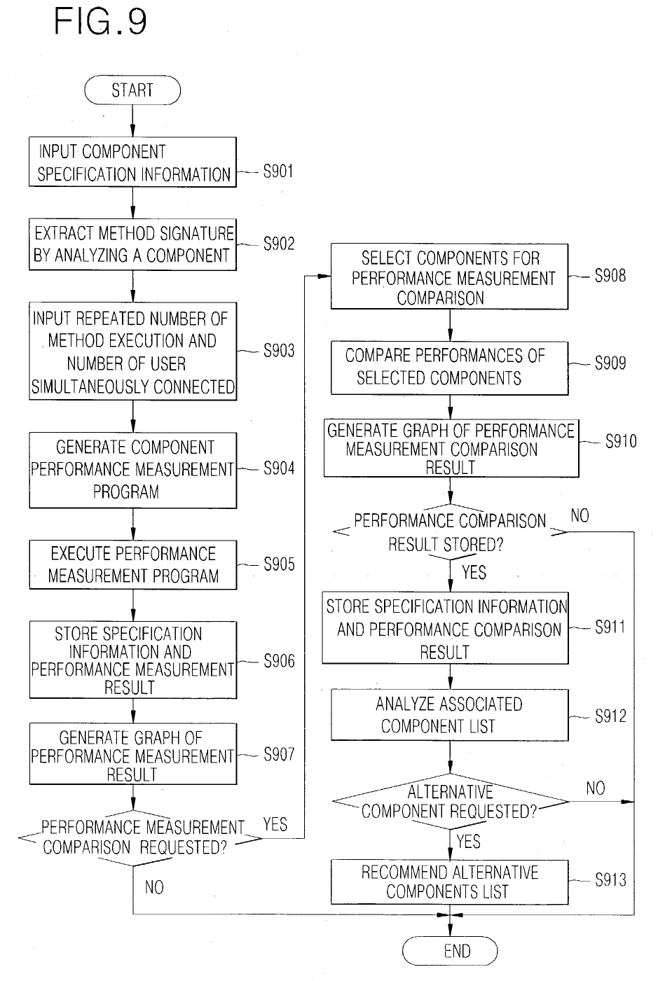

FIG. 9 is a flowchart illustrating a method for recommending alternative components based on a component performance measurement according to the present invention.

As shown in FIG. 9, the component specification information input interface 110 receives the specification information of the component 201 and the application server connection information 202 from the user (step S901).

The component method extractor 120 analyzes what methods are included in the component using the entered specification information of the component, and extracts the method signatures (step S902).

In order to reflect diverse performance measurement scenarios on a performance measurement program, the component performance measurer 130 receives from the user the repeated number of method execution and the number of users simultaneously connected from the user, and prepares information on the component stress test (step S903).

The component performance measurer 130 automatically generates the program for measuring the component performance based on the extracted component method signature information, the application server connection information, the repeated number of method execution, and the number of users simultaneously connected (step S904).

Also, the component performance measurer 130 calls the functions of the component deployed in the application server 200 by executing the generated performance measurement program, and then measures the performance of the component such as the method response time, component response time, CPU usage rate, a memory usage rate, summation information of method response time, summation information of CPU variation amount, and summation information of memory variation amount (step S905).

If the performances of the component are measured as above, the component performance measurer 130 stores the component specification information, the extracted method signature information and the performance measurement results that are acquired from executing the performance measurement program using each component identification number in the component repository 170 (step S906).

Also, the result graph generator 160 shows to the user the component performance measurement results as a bar graph or bent-line graph on a user's request (step S907).

If a user selects components through the component selection interface for performance comparison 140 and requests the performance comparison of the selected components after the component performance measurement results are stored (step S908), the component performance comparator 150 confirms the performance measurement results of the corresponding components in the component repository 170, and then compares the performances of the components with respect to performance measurement elements (step S909).

Also, for the user's easy understanding of the performance comparison results, the result graph generator 160 shows a performance comparison graph of the CPU usage rate, memory usage rate, method response time, and component response time (step S910).

At this time, if the user is satisfied with the performance comparison results and want to store the results, the result graph generator stores the list of the performance-compared components and the performance measurement results in the component repository 170 (step S911).

The associated component analyzer 180 generates association rules by automatically analyzing the list information of associated component on which components the specific component is associated with by processing the results of performance comparison and information of the compared component (step S912).

Also, if a user requests the recommendation of the alternative components, the alternative component recommender 190 selects the components with a high degree of association and confidence, using the associated component list information (association rules) analyzed through the performance results and the performance measurement result information for each component, and then recommends the selected components to the user in the order of their priority (step S913).

Meanwhile, a method for recommending alternative components using performance measurement results of components according to the present invention includes:

a component specification information input step of receiving a user's input of component specification information, information on the repeated number of method execution, information on the number of users simultaneously connected, and information on application server connection;

a component method extraction step of extracting method signatures of the component from the entered component specification information;

a component performance measurement step of generating a performance measurement program for the component by using the extracted method signature information, the repeated number of method execution, and the number of users simultaneously connected, calling functions of the component and measuring the performance of the component by executing the performance measurement program, and then storing in a component repository the results of the performance measurement of each component;

a component performance comparison step of, if a user selects the components to compare performance measurement results, confirming the performance measurement results of the components, comparing the performances of the selected components according to performance measurement elements, and storing comparison result information and compared performance result log in the component repository;

an associated component list analysis step of searching for a specific associated component list by analyzing the component list information compared at the component performance comparison step, and extracting association rules based on the associated component list; and

an alternative component recommendation step of selecting and recommending alternative components in the order of their association degree for a specific component based on the associated component list information and the performance measurement result information of the specific components if the user requests the alternative component list of the specific component.

As described above, the apparatus and method for recommending alternative components based on performance measurement results of components according to the present invention can elevate the reuse rate of the pre-built components and thus seek the user's convenience by automatically identifying the alternative components requested by the user from a large-capacity component repository.

Also, since the user's effort to search for the reusable components is reduced and the reuse of the components is facilitated, software can be produced more easily and rapidly.

Also, since the performance measurement program which can measure the performances of the components is automatically generated through the analysis of specification information without the source code of the component, the performance measurement program can easily be extended so as to measure diverse performance measurement elements required by the user, the performance measurement of the components can be obtained through the diverse performance measurement elements, and the extended method for providing reusable components can be easily applied.

While the apparatus and method for recommending alternative components based on performance measurement results of the components according to the present invention have been described and illustrated herein with reference to the preferred embodiment thereof, it will be understood by those skilled in the art that various changes and modifications may be made to the invention without departing from the spirit and scope of the invention as defined in the appended claims.

What is claimed is:

1. An apparatus for recommending alternative components based on performance measurement results of components, the apparatus comprising:
a component specification information input interface for receiving a user's input of component specification information and application server connection information;
a component method extractor for extracting method signatures of the component from the entered component specification information;
a component performance measurer for generating a performance measurement program for the component using the extracted method signature information, the repeated number of method execution inputted by the user, and the number of users simultaneously connected, calling the functions of the component deployed in the application server by executing the performance measurement program, and then measuring a performance of the component;
a component selection interface for performance comparison for selecting the components to compare performance measurement results from the performance-measured components;
a component performance comparator for confirming the performance measurement results of the selected components and then comparing the performances of the components according to performance measurement elements;
a result graph generator for generating a graph for each performance element using performance measurement results from the component performance measurer to show the graph to the user, and generating a graph for each performance element of presenting performance comparison results of the components from the component performance comparator to show the graph to the user;
a component repository for storing specification information of each component, the performance measurement result information, the performance comparison result information, and components comparison list information;
an associated component analyzer for searching for a specific associated component list by analyzing the components whose performances are compared frequently and extracting association rules based on the associated component list; and
an alternative component recommender for selecting and recommending alternative components in the order of their association degree of the specific component based on the association rules and the performance measurement result information of each component if the user requests the alternative component list of the specific component.

2. The apparatus of claim 1, wherein the component performance measurer measures a performance of the method response time, a performance of a component response time calculated as a sum of the method response time, a performance of a CPU usage rate, a performance of a memory usage rate, method response time summation information, CPU variation amount summation information, and memory variation amount summation information.

3. The apparatus of claim 1, wherein the component performance comparator shows users the performance comparison results as the graph according to the performance elements through the result graph generator. If the user wants to store the performance comparison result, the component performance comparator stores performance list information of the components that are compared together. Each component can be identifiable in the component repository.

4. The apparatus of claim 1, wherein in generating the performance graph for the component performance measurement result of the component performance measurer and the performance comparison result of the component performance comparator, the result graph generator generates a bar graph by component names or method signatures with respect to the performance of the component response time or the performance of the method response time, and generates a bent-line graph by variation of the CPU usage rate or the memory usage rate per time unit with respect to the performance of the CPU usage rate or the performance of the memory usage rate.

5. The apparatus of claim 1, wherein the associated component analyzer finds the association rules for each component item by numerically calculating a support and a confidence of the components, and extracts the components with the support and confidence higher than a specific level from the associated component list.

6. The apparatus of claim 5, wherein the associated component analyzer calculates the support of each component item by the number of selections of the specific component as the subject of comparison, and calculates the confidence as a degree of the user's comparison of the specific component with other components in order to express the confidence of association between the specific component and other components.

7. The apparatus of claim 1, wherein the alternative component recommender selects the alternative components in the order of their association priority with respect to the specific component using a support and a confidence of the association rule that is extracted from the associated component list information, an average and a deviation of performance measurement items that is performance measurement result information of each component, the number of methods that show the minimum response time, and the number of methods that show the maximum response time.

8. The apparatus of claim 7, wherein the alternative component recommender preferentially recommends the alternative components with the high support and confidence and in case that the components have the same support and confidence, the alternative component recommender selects and recommends the alternative components in the order of their high average of performance measurement items, small deviation, a large number of methods that show the minimum response time, and a small number of methods that show the maximum response time.

9. A method for recommending alternative components based on performance measurement results of components, the method comprising:
a component specification information input step of receiving a user's input of component specification information, information on the repeated number of method execution, information on the number of users simultaneously connected, and information on application server connection;
a component method extraction step of extracting method signatures of the component from the entered component specification information;
a component performance measurement step of generating a performance measurement program for the component by using the extracted method signature information, the repeated number of method execution, and the number of users simultaneously connected, calling functions of the component and measuring the performance of the component by executing the performance measurement program, and then storing in a component repository the components results of the performance measurement of each component;
a component performance comparison step of, if a user selects components to compare performance measurement results, confirming the performance measurement results of the components comparing the performances of the selected components according to performance measurement elements, and storing comparison result information and performance a compared performance result log in the component repository;
an associated component list analysis step of searching for associated component lists by analyzing the component list information compared at the component performance comparison step, and extracting association rules based on the associated component list; and
an alternative component recommendation step of selecting and recommending alternative components in the order of their association degree for a specific component based on the associated rules information and the performance measurement result information of the specific component if a user requests the alternative components of a specific component.

10. The method of claim 9, wherein the component performance measurement step measures a performance of a method response time, a performance of a component response time calculated as a sum of the method response time, a performance of a CPU usage rate, a performance of a memory usage rate, the method response time summation information, the CPU variation amount summation information, and the memory variation amount summation information.

11. The method of claim 9, wherein the component performance comparison step shows users the performance comparison results using the graph according to the performance elements through the result graph generator. If the user wants to store the performance comparison result, the component performance comparator stores list information of the components that are compared together. Each component can be identifiable in the component repository.

12. The method of claim 9, wherein the associated component analysis step finds the associated component list by generating component items and numerically calculating a support and a confidence for the generated component items, and extracts association rules from the associated component list.

13. The method of claim 9, wherein the alternative component recommendation step selects the alternative components in the order of their association priority for the specific component using a support and a confidence of the association, an average and a deviation of performance measurement items that is the performance measurement result information of the specific component, the number of methods that show the minimum response time, and the number of methods that show the maximum response time.

14. The method of claim 13, wherein the alternative component recommendation step preferentially recommends the alternative components with the high support and confidence for the specific component, and in case that the components have the same support and confidence, the alternative component recommender selects and recommends the alternative components in the order of their high average of performance measurement items, small deviation, the large number of methods that show the minimum response time, and the small number of methods that show the maximum response time.
